(19) United States
(12) Patent Application Publication
(10) Pub. No.: US 2023/0026597 A1
(43) Pub. Date: Jan. 26, 2023

(54) MATRIX PRESSURE SENSOR WITH NEURAL NETWORK, AND CALIBRATION METHOD

(71) Applicant: COMMISSARIAT A L'ENERGIE ATOMIQUE ET AUX ENERGIES ALTERNATIVES, Paris (FR)

(72) Inventors: Adrien BARDET, Grenoble (FR); Franck VIAL, Grenoble (FR); Saifeddine ALOUI, Grenoble (FR)

(73) Assignee: COMMISSARIAT A L'ENERGIE ATOMIQUE ET AUX ENERGIES ALTERNATIVES, Paris (FR)

(21) Appl. No.: 17/872,121

(22) Filed: Jul. 25, 2022

(30) Foreign Application Priority Data
Jul. 23, 2021 (FR) 2107976

(51) Int. Cl. G01L 5/00; G01L 1/18; G01L 1/26; G01L 1/14; G06V 10/82

(52) U.S. Cl. CPC G01L 5/0066; G01L 1/18; G01L 1/26; G01L 1/14; G06V 10/82

(57) ABSTRACT

Matrix pressure sensor with neural network, and calibration method

Matrix pressure sensor (1), comprising:
a matrix (2) of tactile pixels (10) at least some of which have a reciprocal crosstalk effect between them,
a neural network (30) for processing an image (I_{P_MES}) of the response from the sensor and providing a corrected image (I_{P_COR}), this network having been trained from an augmented database (BD_{AUG}) comprising:
   real homogeneous pressing data measured by applying a homogeneous pressure (P_{R}) to at least some of the pixels, better still to all of the pixels of the matrix, and
   additional partial pressing data produced through simulation by applying binary masks (MAS) to the real homogeneous pressing data, so as to simulate partial pressing without a crosstalk effect with the pixels situated outside partial pressing areas.

### TECHNICAL FIELD

The present invention relates to pressure sensors, and more particularly to matrix pressure sensors.

### PRIOR ART

Tactile perception is important for certain robotic applications. To allow robots to perform tasks close to those of humans, for example those involving holding and/or manipulating an object, it is desirable to know how to measure certain properties of the contact between an external object and a surface, in particular the pressure or distribution of pressure exerted on the contact area.

It is known to use a matrix pressure sensor, that is to say a sensor comprising a plurality of sensitive measuring elements, called pixels, to measure a distribution of pressure exerted on a surface.

However, due to their design and their assembly, the pixels generally have responses that are inhomogeneous and sometimes dependent on those of their neighbors, in particular if the pressing at the origin of the pressure is not applied to all of the pixels of the matrix.

To take into account the abovementioned phenomena and compensate for the associated non-linearity effects, the sensor is subjected to a calibration phase before it is used.

In the case of a “single-pixel” pressure sensor, one conventional calibration method consists in applying a plurality of known force increments to the sensor, recording the associated responses and determining a mathematical model based on these measurements so as then to be able to extrapolate the correction to any new measurement of the sensor.

This approach may be applied to a matrix sensor, as described in patent CN101281073, which discloses a calibration method in which the response from the sensor to a reference force is measured for various forces and for each pixel of the matrix. However, this acquisition method is longer when the matrix comprises more pixels, and does not make it possible to take into account any dependency of the response from a pixel with respect to those of its close neighbors, a phenomenon known as crosstalk between the pixels.

In application CN110174213, the pixels are subjected collectively to a reference force with the aid of a plate that covers the whole surface, so as to load the pixels simultaneously and equally. The individual responses from the pixels are recorded and then calibrated using a mathematical model coupled to a data adjustment algorithm, such as the least squares or maximum likelihood method. This application CN110174213 also discloses a method for dealing with crosstalk with a corrective coefficient calculated via an algebraic law, said law being based on a linear combination of the calibrated responses from the pixel to be corrected and the adjacent pixels. However, this calibration method requires a priori knowledge of the algebraic correction law, this not being a simple matter as it depends on the features of the matrix and the form of the pressing on the surface.

In addition, any modification to the layout of the pixels within the matrix means having to find a new algebraic correction law, which may turn out to be particularly difficult for certain configurations.

### DESCRIPTION OF THE INVENTION

There is therefore a need to further refine matrix pressure sensors, in particular in order to have a sensor that makes it possible to measure the distribution of pressure exerted during various types of pressing, and the calibration of which is relatively simple, fast and generally applicable to various types of matrices.

### SUMMARY OF THE INVENTION

The invention aims to address this need, and does so, according to a first of its aspects, by virtue of a matrix pressure sensor comprising
a matrix of tactile pixels at least some of which have a reciprocal crosstalk effect between them,
a neural network for processing an image of the response from the sensor and providing a corrected image, this network having been trained from an augmented database comprising:
   real homogeneous pressing data measured by applying a homogeneous pressure to at least some of the pixels of the matrix, better still to all of the pixels of the matrix, and
   additional partial pressing data produced through simulation by applying binary masks to the real homogeneous pressing data, so as to simulate partial pressing without a crosstalk effect with the pixels situated outside partial pressing areas.

The sensor according to the invention allows a reliable measurement of the pressure exerted during pressing, including pressing in a non-simple form, and for regular or irregular layouts of the pixels within the matrix.

Tactile Pixels

The pixels may be piezoresistive or capacitive, preferably piezoresistive.

The invention applies to various pixel distributions. The pixels may be distributed regularly in one or two directions X, Y of the matrix, for example with a pitch along X that is the same as the pitch along Y. As a variant, the pixels are distributed over the matrix with an irregular distribution in at least one direction. This may allow a gain in precision, for example by increasing spatial resolution, in the areas where there is a need for the greatest precision. The presence of the neural network makes it possible to easily calibrate the sensor, including for such configurations.

For piezoresistive pixels, the sensor has for example one of the following structures:
a) A first layer of a conductive polymer,
an array of column electrodes on the outer face of this first layer of conductive polymer,
a second layer of a conductive polymer facing the first layer,
an array of row electrodes on the outer face of this second layer of conductive polymer;
b) A layer of piezoresistive material, an array of column electrodes on a face of this layer of piezoresistive material, and an array of row electrodes on the face opposite this layer of piezoresistive material;
c) A first electrically insulating carrier layer, an array of column electrodes on the inner face of this first carrier layer, a layer of a conductive polymer having a first face facing the array of column electrodes, an array of row electrodes facing the second face of the layer of conductive polymer, and a second electrically insulating carrier layer, on the inner face of which the row electrodes are arranged; or
d) A substrate, row and column electrodes on one and the same face of this substrate, and a layer of a conductive polymer facing these row and column electrodes.

Other types of structure are conceivable, in particular hybrid structures between those that have just been described.

The row or column electrodes may be rectilinear and spaced with a constant pitch and be perpendicular to one another; as a variant, the row and/or column electrodes may be spaced with a variable spacing, for example that decreases in a central region of the sensor.

Other row and column electrode geometries are possible.

### Temperature Sensor

The sensor according to the invention may comprise a temperature sensor, the neural network having been trained so as to take into account the influence of temperature on the behavior of the pixels, by taking the temperature as additional input.

It is thus possible to take into account the influence of temperature on for example the elasticity or the resistivity of the materials of the sensor. The temperature sensor may be integrated into the pixel matrix or situated elsewhere.

The sensor according to the invention may, where appropriate, comprise a plurality of temperature sensors, for example located in various areas of the matrix.

The sensor according to the invention may also be placed in a room or a chamber with a controlled ambient temperature, the temperature sensor measuring the ambient temperature.

### Processor

The sensor preferably comprises a processor for acquiring an image of the response from the sensor by reading out the pixels sequentially; preferably, each pixel that is read out is supplied with power and all of the other pixels that are not read out are grounded during this readout operation, thereby making it possible to electrically isolate the pixel that is read out and to reduce readout imprecision, in particular by improving the spatial precision of the measurement.

A “processor” should be understood in the broad sense as any type of electronic equipment for performing the required functions; for example, the processor is a microcontroller card or the like, and may comprise a non-volatile memory along with various interface circuits, for example for A/D conversion.

The neural network may be implemented with the same processor as the one that acquires the response from the pixels or with any other electronic card or circuit.

### Neural Network

The neural network may have several types of architecture.

The neural network comprises for example a single convolutional layer and at least one dense layer. The advantage of such an architecture is that of performing only relatively simple computations, which are therefore fast to execute and easily portable within a lightweight computing unit such as a microcontroller.

As a variant, the neural network comprises convolutional layers and deconvolutional layers. The advantage of such an architecture is that of having a small number of parameters to be stored.

### Calibration Method

Another subject of the invention is a method for calibrating a tactile sensor, in particular as defined above, comprising a matrix of tactile pixels at least some of which have a reciprocal crosstalk effect between them, this method comprising the following steps:
applying a homogeneous pressure to at least some of the pixels, better still to all of the pixels,
thus generating a real homogeneous pressing database by acquiring the response from the sensor for various values of the applied pressure,
generating an augmented database containing additional partial pressing data obtained through simulation by applying binary masks to the real homogeneous pressing data, so as to simulate partial pressing without a crosstalk effect with the pixels situated outside partial pressing areas,
training at least one neural network to deliver a corrected image of the response from the sensor using the augmented database.

To choose the appropriate neural network, a plurality of neural networks with different architectures are preferably subjected to the training, and the one with the best performance is selected by subjecting the sensor to at least one test press different from a press that was used to train the networks, in particular a test press different from a homogeneous press on all of the pixels of the matrix, and by comparing the results produced by these various networks with the real data produced by the test press on the sensor.

The test press consists for example of a homogeneous press exerted on only some of the pixels of the matrix, for example on at least one quarter of the pixels of the matrix.

The neural network may be selected on the basis of at least one selection criterion representative of the difference between the highest pixel response and the lowest pixel response for this test press.

When the sensor has a temperature sensor, the neural network may be trained so as to take into account the influence of temperature on the behavior of the pixels, by taking the temperature as additional input.

A plurality of binary masks may be used at the same time on one and the same image when forming the augmented database, while ensuring that the masks do not overlap.

The masks are for example formed of pixelated ellipsoids for which the values of the major axis, minor axis, orientation and coordinates of their center on the matrix are varied, in particular in order to simulate a one-time press limited to one pixel or pressing of a finger in the shape of a disk.

The geometry of the masks may be chosen based on the nature of the pressing that the sensor is then liable to encounter, in order to make the network specialize in correcting the responses from the pixels to pressing of this nature.

### BRIEF DESCRIPTION OF THE DRAWINGS

The invention will be able to be better understood upon reading the following detailed description of non-limiting exemplary implementations thereof, and upon examining the appended drawing, in which:

FIG. 1 partially and schematically shows one example of a pressure sensor according to the invention,

FIG. 2A partially and schematically shows a cross section of one example of a structure of a pixel comprising electrodes carried by two layers of weakly conductive material,

FIG. 2B partially and schematically shows a cross section of another example of a structure of a pixel comprising electrodes situated on either side of one and the same layer of piezoresistive material,

FIG. 2C partially and schematically shows a cross section of another example of a structure of a pixel comprising electrodes carried by two insulating layers and a layer of conductive polymer,

FIG. 2D partially and schematically shows a cross section of another example of a structure of a pixel comprising electrodes on one and the same face of an insulating layer and a layer of conductive polymer,

FIG. 3 schematically and partially shows one example of measuring electrical resistance between the electrodes of a matrix,

FIG. 4 is a block diagram illustrating one example of a method for reading out the pixels of a matrix,

FIG. 5 illustrates a partial and schematic front-on view of a matrix comprising pixels distributed with an irregular distribution,

FIG. 6 is a block diagram illustrating one example of a method for calibrating a tactile sensor according to the invention,

FIG. 7 schematically and partially shows certain details of the first step of the calibration method of FIG. 6,

FIG. 8A is one example of pressure images measured by a matrix sensor of a size of 8×8 pixels when it is subjected to various homogeneous forces,

FIG. 8B shows the reference images corresponding to the various homogeneous forces exerted on the sensor in FIG. 8a.

FIG. 9 schematically and partially shows one example of a binary mask applied to an image of FIGS. 8a and 8b,

FIG. 10 schematically and partially shows examples of inhomogeneous loads on the sensor used for the third step of the method of FIG. 3,

FIG. 11 schematically illustrates the possibility of using a neural network to correct measured pressure images when the sensor is subjected to inhomogeneous loads such as that of FIG. 10,

FIG. 12 schematically and partially illustrates one example of an architecture of a neural network of the sensor according to the invention, and

FIG. 13 schematically and partially illustrates another example of an architecture of a neural network of the sensor according to the invention.

### DETAILED DESCRIPTION

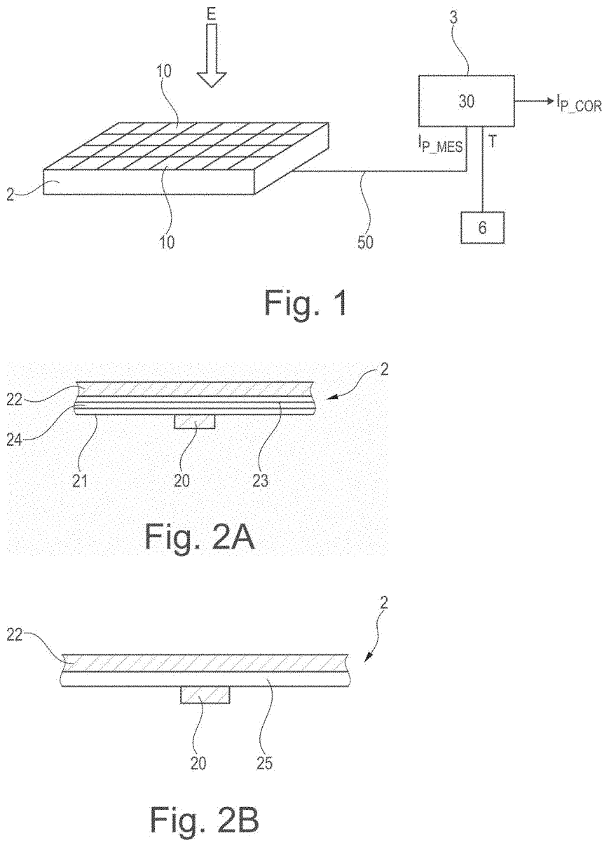

FIG. 1 illustrates one example of a pressure sensor 1 according to the invention. The sensor 1 comprises a matrix 2 of tactile pixels 10. In the example under consideration, the pixels 10 are distributed regularly in a grid, defining for example a substantially flat surface on which a force E may be exerted.

The sensor 1 comprises a processing circuit 3 connected to the matrix 2, for example by a wired link 50, which processes the response I_{P_MES} from the matrix 2 using an artificial neural network 30 in order to provide a corrected response I_{P_COR}.

In the example under consideration, the response I_{P_MES} is the pressure “image” measured by the matrix 2 when it is subjected to the force E, said image comprising pixels representing the pressure measured individually by each of the pixels 10.

The response I_{P_MES} consists for example of values encoded on integers signed on 16 bits.

The corrected response I_{P_COR} is the pressure image corrected so as to take into account certain defects with the sensor 1, such as any non-linearity of its response, the reciprocal crosstalk effect between certain pixels, and possibly its temperature dependency.

The neural network 30 is trained beforehand in a phase of calibrating the sensor 1, as is described below.

The sensor 1 may also be designed to measure at least one variable other than the pressure exerted on the matrix. It may comprise a temperature sensor 6, as illustrated in FIG. 1, thereby making it possible to take into account the influence of temperature on the response from the pixels.

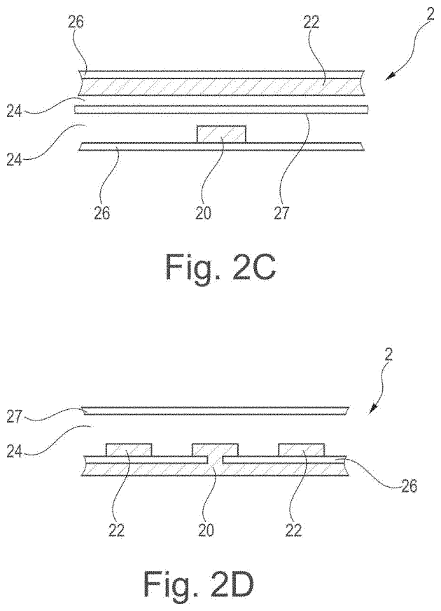

The matrix 2 of pixels 10 is for example piezoresistive. In this case, the pixels 10 may be formed in various ways, some of which are shown in FIGS. 2a, 2b, 2c and 2d.

As illustrated in FIG. 2a, a first electrode 20 may be printed on a layer of weakly conductive material 21, for example a polymer loaded with carbon particles, and a second electrode 22 may be printed on another layer of weakly conductive material 23.

The layers 21 and 23 are then stacked such that the electrodes 20 and 22 are arranged on the outside of the assembly. The two layers 21 and 23 are for example separated by a small air gap 24, and touch one another with satisfactory electrical contact only when a pressure is exerted on the assembly.

In the example of this figure, the electrodes 20 and 22 each have a linear shape and are arranged perpendicular to one another.

A pressure P exerted on the matrix 2 varies the contact area between the layers 21 and 23, thereby leading to a change in electrical resistance in the measuring area where the electrodes 20 and 22 intersect. This variation in electrical resistance may be measured in various ways. For example, a voltage is applied between the electrodes and the corresponding current is measured. It is also possible to measure the voltage across the terminals of the resistor using the resistive divider bridge technique, or by injecting a known current.

In one variant illustrated in FIG. 2b, the electrodes 20 and 22 are printed on either side of one of the same layer of intrinsically piezoresistive material 25, which deforms under the action of the forces exerted on the matrix 2, leading, in a manner similar to the previous example, to a variation in electrical resistivity in the area of intersection of the electrodes.

In other variants, the electrodes are carried by an insulating substrate, in particular a flexible one, for example made of PET. The electrodes 20 and 22 are for example each printed or deposited on an electrically insulating flexible layer 26 and face one another, as illustrated in FIG. 2c. A weakly conductive layer 27, for example a polymer loaded with conductive particles, possibly with a cellular structure, or else with a piezoresistive material, is sandwiched between the electrodes 20 and 22 and separated from each electrode 20 or 22 by a small air gap 24.

In the variant of FIG. 2d, the electrodes 20 and 22 are carried by one and the same electrically insulating substrate 26, facing a weakly conductive layer 27, for example a compressible cellular material, or a non-cellular material. The electrodes are separated from the layer 27 by a small air gap 24. When a force is exerted on the matrix 2, the layer 27 may come into contact with some of the electrodes.

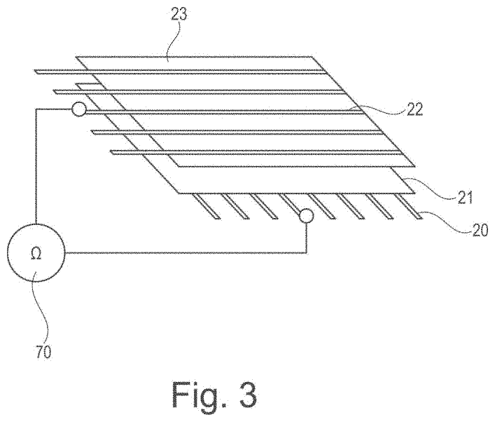

It is possible to produce all of the pixels 10 of the matrix 2 by printing N parallel electrodes on one face of the matrix, for example on a layer of weakly conductive material 21, and M parallel electrodes on the other face, for example a layer of weakly conductive material 23, the M electrodes being arranged perpendicular to the N electrodes, as illustrated in FIG. 3. In this example, N denotes the number of rows of the matrix 2, M denotes the number of columns, and the intersection of the electrodes defines the pixels 10.

Since the material of the layers 21 and 23 is preferably electrically isotropic, a press between two adjacent pixels 10 also generates a variation in electrical resistivity for these two pixels. A press on one pixel may thus “spill over” electrically onto its neighbors, and therefore generate a reciprocal crosstalk phenomenon.

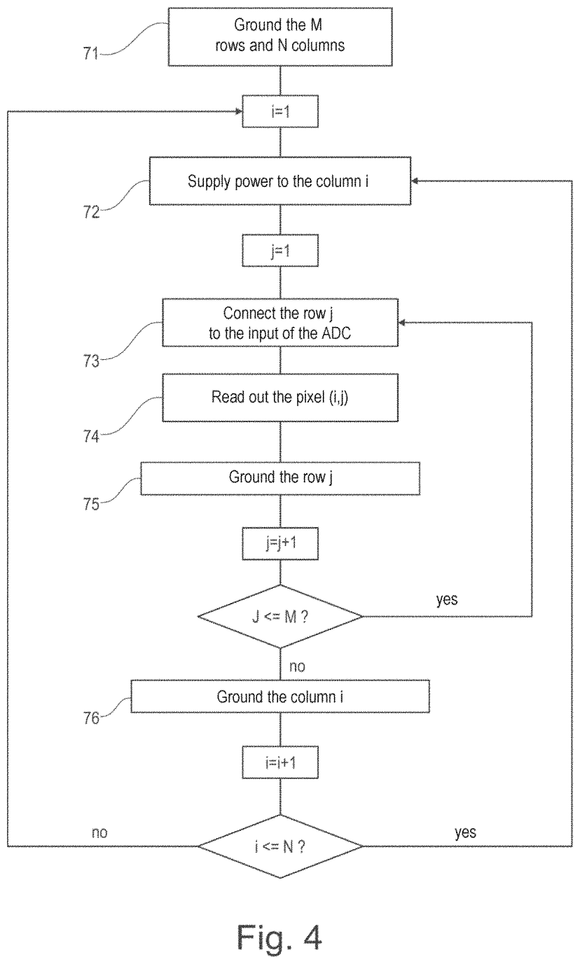

It is possible to implement a scanning-based method for reading out the pixels 10, such as the one illustrated in FIG. 4. This method, described below, uses a method similar to the one proposed in the article “The UnMousePad-An Interpolating Multi-Touch Force-Sensing Input Pad” by Rosenberg et Al (ACM SIGGRAPH 2009 papers. 2009. 1-9).

In the first step 71 of the readout method, all of the electrodes are grounded.

The following steps are then repeated, where i is an integer between 1 and N:
In step 72, the electrode i is supplied with power, and
The following are repeated, where j is an integer between 1 and M:
   In step 73, the electrode j is connected to the input of a readout circuit,
   In step 74, the signal on the measurement area corresponding to the intersection of the electrodes i and j is read out, and
   In step 75, the electrode j is grounded, and
The electrode i is grounded.

This sequential readout method, by supplying power to each of the pixels 10 in turn, while at the same time grounding the other electrodes (not shown in FIG. 3), advantageously makes it possible to limit measurement artefacts, such as “phantom” signals, linked to current leakage paths within the detection structure. The electronic components, by virtue of the path multiplexing, are able to be pooled to a greater extent, thereby possibly reducing the cost of manufacturing the sensor. As a variant, a plurality of analog/digital converters are used with or without path multiplexing, in particular one converter per electrode j connected to the readout circuit.

The number and the distribution of the pixels 10 are of course not limited to the example that has just been described; other layouts are possible.

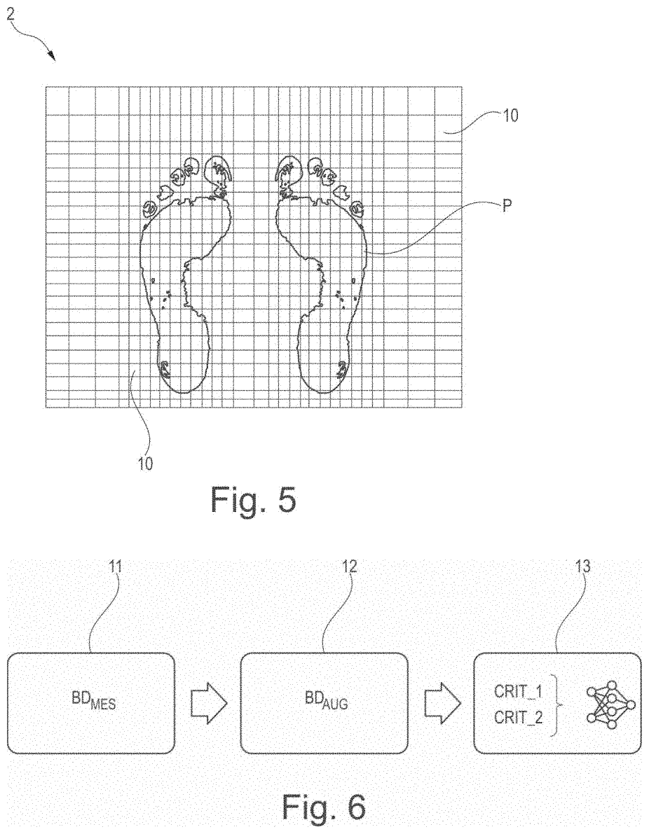

The pixels 10 may thus also be distributed with an irregular distribution, as illustrated in FIG. 5, thereby making it possible to obtain a finer resolution in certain areas of the matrix depending on the application. In the example of the podoscope pad illustrated in FIG. 5, the pixel density is higher in the potential pressing areas for the feet P, and less at its periphery.

The sensor 1 is preferably placed in a room or a chamber with a controlled ambient temperature and the temperature sensor 6 transmits the measurement of the ambient temperature T to the neural network 30 at the time of acquisition of the data IP_MES from the matrix 2.

A description will now be given of one example of a method for calibrating the matrix pressure sensor with reference to FIGS. 6 to 9.

In the example under consideration, the calibration method comprises three steps 11, 12 and 13, as shown in FIG. 6.

In step 11, a database BD_{MES}s of real homogeneous pressure measurements is formed. For this purpose, the sensor 1 is subjected, over the whole of the matrix 2, to a given homogeneous pressure force P_{R}, and the responses from each pixel to this force are measured and recorded.

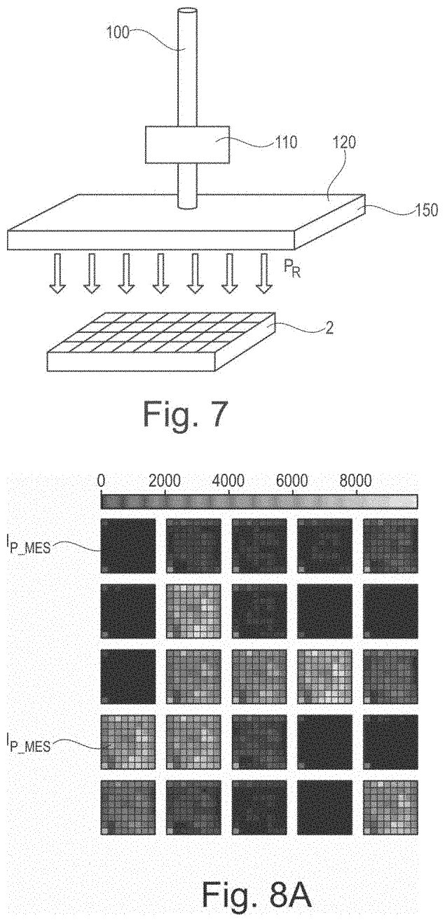

To apply a given homogeneous pressure P_{R}, a plate 120 is for example fixed to the mobile head 100 of a measurement bench comprising a reference force sensor 110, as illustrated in FIG. 7. The sensor 110 measures the pressure P_{R}, also denoted “reference pressure” hereinafter, applied to the matrix 2.

The plate 120 preferably has dimensions larger than the matrix 2 of the sensor to be calibrated.

In order to spatially homogenize the pressure P_{R} applied to the matrix 2, it is possible to add a layer 150 of a deformable material between the plate 120 and the matrix 2. The layer 150 comprises for example an envelope made of deformable elastomer filled with water, with a highly flexible silicone grease gel or else with a compressible fluid such as air. The elastomer envelope is preferably relatively inelastic, in order to avoid any lateral creep during pressing and to promote the transmission of forces from the plate 120 to the matrix 2.

The layer 150 has dimensions larger than the matrix 2 and makes it possible to conform with the surface of the matrix 2 while compensating for any coplanarity defects between the plate 120 and the matrix 2, these defects otherwise possibly leading to pressures that are locally higher.

The layer 150 also makes it possible to transmit even relatively weak forces to all of the pixels 10 at the same time, for example after a first press that allows it to store the fingerprint of the matrix 2.

For the calibration, N_{C} reference pressure values P_{R} covering the interval of the dynamic range able to be measured by the matrix 2 are for example chosen.

The N_{C} reference pressure values may be sampled uniformly, for example by selecting 41 values per pitch of 1 newton between 0 and 40 newtons.

The sampling may also follow another distribution law, for example a logarithmic one, in particular when the response from the pixels 10 is not linear and tends for example to flatten out for high forces. Discretizing the highest pressure values P_{R} more finely thus makes it possible to adapt to the response from the pixels while still retaining a reasonable calibration duration.

The N_{C} chosen reference pressure values P_{R} may be applied randomly in order to avoid any memory effect of the matrix, and repeated, for example 3 times, in order to introduce redundancy and average the responses.

Each pressure value P_{R} is for example kept for a few seconds in order to allow the system to find its mechanical equilibrium and to acquire enough stabilized measurements so as then to take a temporal average therefrom.

The theoretical pressure perceived by each pixel 10 is equal to the pressure P_{R} divided by the number of pixels N_{P}. It is chosen for example to subject each pixel to a pressure that varies between 0 and 2 newtons, this corresponding to an applied reference pressure P_{R} of between 0 and (2×N_{P}) newtons.

The mobile head 100 may be mounted on a spring-based damping system so as to be able to absorb a vertical displacement as the exerted pressure P_{R} increases. This makes it possible to increase the vertical displacement travel for a given range of forces and to relax constraints on the resolution of the control of the displacements.

It is possible to use software to temporally synchronize the real pressure data measured by the matrix 2 with the associated reference pressures P_{R} measured by the sensor 110.

The data may be post-processed in order to isolate the N_{C} periods over which the responses from the N_{P} pixels are stable, and for each of these periods, to calculate the average value of each of the pixels 10 along with the average value of the reference pressure P_{R}.

The results are saved in the database BD_{N}s in the form of a table with dimensions (N_{P}+1)×N_{C},

N_{P} denoting the number of pixels 10,

N_{C} denoting the number of reference pressure values P_{R} tested, and

“+1” corresponding to the reference pressure P_{R}.

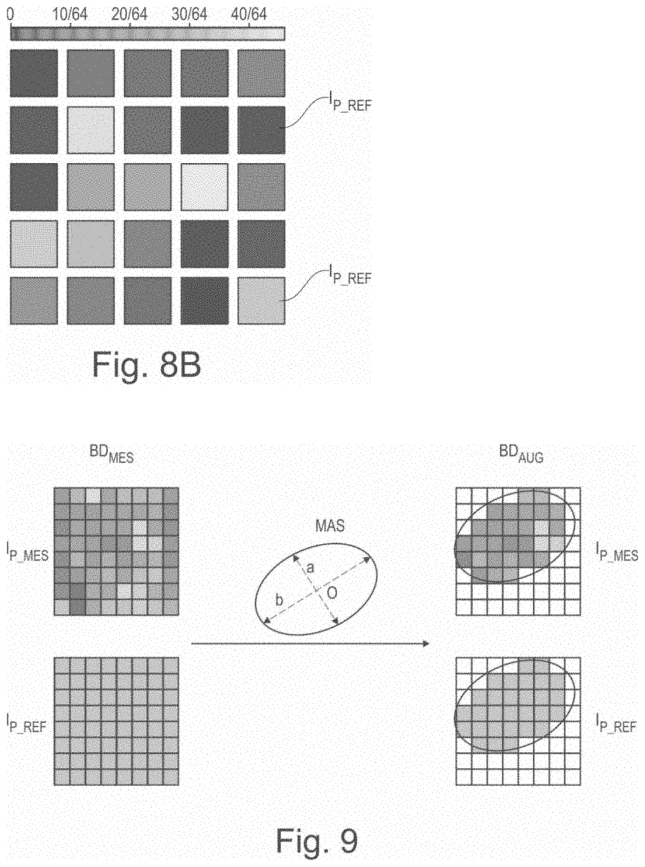

The real pressure data may be represented in the form of a pressure image I_{P_MES}, as described above and as shown in FIG. 8a for 25 pressure images delivered by a matrix of 8×8 pixels, i.e. N_{P}=64.

These 25 images represent the response from the sensor to 25 reference pressure values P_{R} to which the matrix 2 has been homogeneously subjected, and may be compared with reference images I_{P_REF} as shown in FIG. 8b, in which all of the pixels 10 have an identical value equal to P_{R}/N_{P}, where N_{P}=64 and P_{R} varies between 0 and approximately 45 newtons. The pressure values of the pixels 10, which are identical with a reference image IP REF, may thus vary from one reference image to another between 0 and (45/64) newtons.

In contrast to the applied pressure, the pressure images I_{P_MES} appear pixelated, with different values for certain pixels, indicating that the responses from the pixels are not homogeneous and that a correction is needed.

Step 11 may be repeated for various temperature conditions if desired. In this case, the database BD_{MES} is reproduced as many times as temperature values are imposed, for example every 10° C. between 0° C. and +40° C. for indoor applications.

In step 12, an augmented database BD_{AUG} containing additional partial pressing data is generated.

These additional data are obtained through simulation from the database BDMs by applying binary masks to the homogeneous pressing data.

This step makes it possible to enrich the database BD_{MES}, which contains only data relating to the responses from the sensor to homogeneous pressures exerted on the matrix 2, this enrichment taking place without new measurements being performed.

A “binary mask” here denotes a geometric mask that, when applied to the images I_{P_MES} and I_{REF} from the database BD_{P_MES}, preserves the measurements of the pixels 10 and of the reference pressure P_{R} contained under this mask, while at the same time forcing the responses from the pixels situated outside this mask to 0.

Forcing responses to 0 is tantamount to canceling out the reciprocal crosstalk between the pixels 10 that are loaded and those that are not loaded by the mask.

The binary masks are for example defined by one or more pixelated ellipsoids, with one pixel of the mask equal to one pixel of the matrix, as illustrated in FIG. 9 for a mask MAS applied to a measured image I_{P_MES} and its reference image I_{P_REF}, for a matrix of 8×8 pixels.

The masks are for example parameterized by the number of ellipsoids and the values of their minor axis a, major axis b, orientation, and coordinates of their center O on the matrix. In the illustrated example, the center O of the mask MAS is situated on the pixel 4/4 (4^{th} column and 4^{th} row). Of course, any other positioning is conceivable.

These parameters thus make it possible to generate masks ranging from a single pixel, which represents for example very localized pressing, to a disk (to represent the pressing of a finger), a cross, a rectangle, or any other shape of interest.

These parameters may be chosen randomly, or so as to cover all possible combinations for a given matrix 2.

It is also possible to modify the number of masks in order to simulate multiple simultaneous presses on the matrix 2 and, where appropriate, generate a final image I_{P_MES} by applying a combination of several masks to one and the same given pressing level, or to different pressing levels using the various associated images I_{P_REF}, and by summing the corresponding masked images.

In order to avoid problems in terms of discontinuity of applied forces, it is ensured that the masks do not overlap, by applying for example a dilation of at least one pixel between two adjacent masks, by calculating the result of a logic “AND” function between the masks and then by checking that the sum is equal to 0. If the sum is greater than 0 (indicating that the masks overlap), this combination of masks is not selected.

Generating M sets of masks thus makes it possible to increase the size of the base BD_{MES} by a factor M. By way of example, for a matrix of dimensions 8×8 pixels, covering all possible mask configurations while drawing a limit at just 1 mask and while setting the orientation of the ellipsoid to 0° is tantamount to increasing the base BD_{MES} by a factor 4×4×64=1024 (4 minor axis values, 4 major axis values, 8×8=64 positions of the center).

In step 13, the neural network 30 is trained to deliver a corrected pressure image I_{P_COR} of the response from the sensor using the augmented database BD_{AUG}.

By virtue of the enrichment of the data performed in step 12, the neural network 30 is trained with forms other than just homogeneous presses on all of the pixels of the matrix 2, thereby making it possible to improve calibration and correction performance.

Training the neural network 30 consists in determining the parameters of the model, that is to say here modulating the synaptic weights of the network, so as to make the responses from the pixels 10 tend towards the real pressure value to which they are subjected.

For example, for a homogeneous pressure P_{R} applied to the whole matrix 2, this involves homogenizing the responses among the pixels 10 towards the constant value P_{R}/N_{P}, where N_{P} is the number of pixels.

To this end, it is possible to follow learning methods known to a person skilled in the art, for example based on error backpropagation. The database BD_{AUG} is split for example into two subsets, one used for the phase of training the network, and the other for validating the network thus determined.

Before starting the training, each responsible from a pixel 10 is preferably normalized by its maximum value attained in the database BD_{AUG}.

In the training phase, the neural network 30 is provided with the measured images I_{P_MES} of the first subset, some of them originating from direct data obtained in step 11 and others from additional data generated in step 12, along with the associated reference images IP REF.

In the validation phase, the neural network 10 is provided with the measured images I_{P_MES} of the second subset, and the corrected images I_{P_COR} generated at output by the neural network are compared with the reference images I_{P_REF}.

A first validation criterion CRIT1 for validating the performance of the network may be defined by a mean squared error (MSE) between the corrected images I_{P_COR} and the reference images I_{P_REF} that is below a certain threshold, for example 0.01.

On the other hand, to evaluate the performance of the network, it is possible to use an additional criterion CRIT2 characterizing the ability of the neural network 30 to generalize a correction to images I_{P_MES} that do not belong to the database BD_{AUG}.

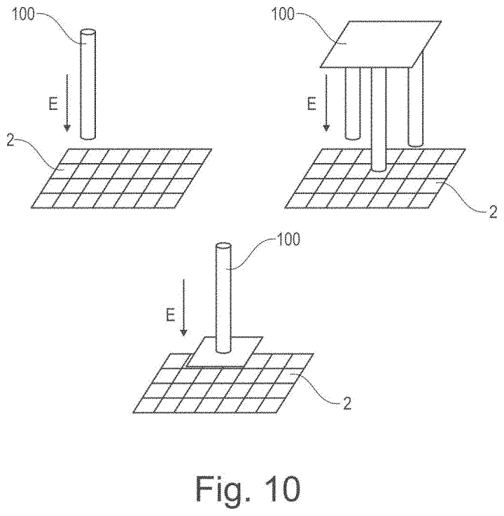

A new database BD_{MES_2} is generated for example using the measurement bench as described in step 11, but by changing the type of pressing applied to the matrix 2. A known reference pressure P_{R} force E is for example imposed on one or more sub-portions of the matrix 2, while modifying the shape and the number of fixed contact points on the head 100 of the bench, as illustrated in FIG. 10.

These points may have pressing area dimensions expressed as a number of pixels 10 of the matrix 2, so as to facilitate the reconstruction of the reference pressure image I_{P_REF}.

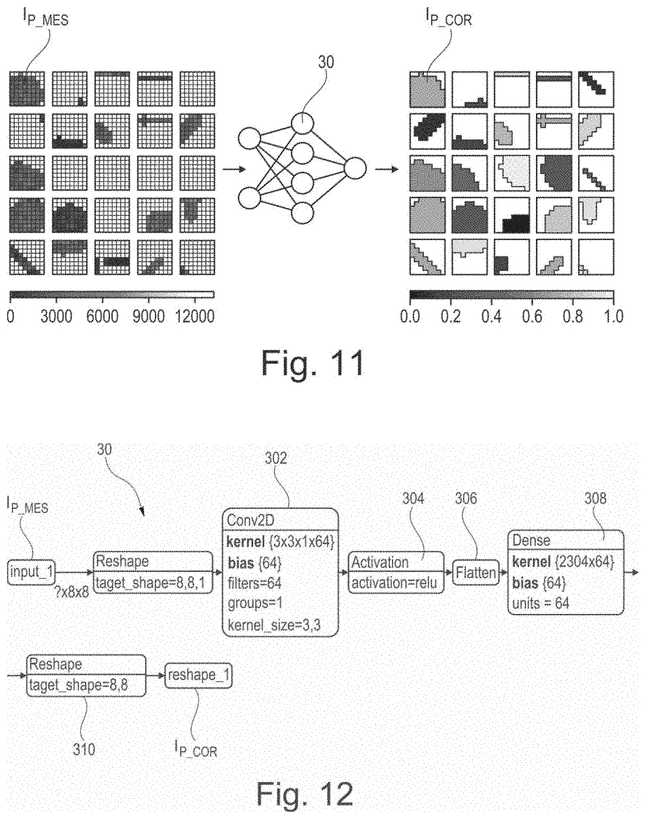

FIG. 11 illustrates one example of corrected images I_{P_COR} generated by the neural network 30 from measured images I_{P_MES} when the matrix 2 is subjected to varied presses of this type.

The additional criterion CRIT2 may be defined in several ways based on the corrected images from the new database BD_{MES_2}.

By way of example, it is considered that N_{C2} reference pressure P_{R} values are applied, each loading N_{P2} pixels of the matrix 2 so as to form the new database BD_{MES_2}.

For each reference pressure value P_{R,K}, where k ∈ [1, N_{C2}], the homogeneity Aₖ of the corrected responses from the N_{P2} loaded pixels is defined by the difference between the highest corrected pixel response Pxcₖ and the lowest pixel response:

Aₖ=max{Pxc_{k,m}}_{m∈[1,N}_{_{P2}}_{]}−min{Pxc_{k,n}}_{n∈[1,N}_{_{P2}}_{]} [Math1]

As a variant, it is possible to define the homogeneity Aₖ of the corrected responses from the N_{P2} loaded pixels by the variance of the corrected pixel responses {Pxcₖ} with respect to the average response Pxc_{k,mean,} for each reference pressure value P_{R,k}:

$${Pxc}_{k , mean} = \frac{1}{{N}_{P 2}} {\sum }_{m = 1}^{{N}_{P 2}} {Pxc}_{k , m} \qquad [ Math 2 ]$$

$${A}_{k} = \frac{1}{{N}_{P 2}} {\sum }_{m = 1}^{{N}_{P 2}} {( {Pxc}_{k , mean} - {Pxc}_{k , m} )}^{2}$$

The criterion CRIT2 then express the homogeneity of the corrected pixel responses {Pxcₖ} subjected to one and the same pressing value P_{R},k for all of the N_{C2} applied pressing values, i.e.:

$$CRIT 2 = \frac{1}{{N}_{C 2}} {\sum }_{k = 1}^{{N}_{C 2}} {A}_{k} \qquad [ Math 3 ]$$

The neural network is deemed to exhibit better performance in the correction of the images the lower the value of the criterion CRIT2. The training of the neural network is for example validated for CRIT2<0.1 (when, as mentioned above, the values of the responses from the pixels have been normalized before the criterion is calculated).

It is possible to use the criteria CRIT1 and CRIT2 described above to select the best-performing neural network out of neural networks with different architectures, by searching for an architecture that minimizes the two abovementioned criteria at the same time.

Generally speaking, a product of the two criteria does not always constitute a sufficient metric to select the desired result, since this result could give preference to a network that exhibits very good performance on the augmented database BD_{AUG} but poor on the new database BD_{MES_2}.

It is possible to use a weighted sum of the various criteria, by defining weights that do not benefit for example some presses rather than others.

For CRIT1<0.01 and CRIT2<0.1, a metric of the type “score=1×CRIT1+0.1×CRIT2” is for example defined and the network that generates the lowest score is selected.

Other types of criteria and/or a greater number of criteria may of course be used to validate and/or select the neural network 30, and the respective weighting thereof in the formula for the score is chosen depending on the desired application and the means available.

For example, the number of synaptic weights of the network under test is taken into account, in particular if the computing system that is used has a small amount of memory (it will then be sought to give preference to a network comprising a low number of weights).

It is also possible to define a criterion on the complexity of the unitary computations performed by the network and/or the number thereof.

Various neural network architectures meet the criteria that have just been described.

Use will be made for example of a neural network having an architecture comprising at least one convolutional layer and one dense layer, also called “fully connected”.

FIG. 12 shows one example of such an architecture for a matrix 2 of dimensions 8×8 pixels. The neural network 30 comprises a first convolutional layer 302 of 64 filters using kernels of size 3×3, with ReLU activation 304. This layer is followed by a flattening layer Flatten 306 that transforms the output of the convolution into a ID vector. Finally, a dense layer 308 of 64 neurons (8×8) is applied and a reshaping layer Reshape 310 is used to return to 2D (8×8).

Such an architecture has the advantage of performing only relatively simple computations, which are therefore fast to execute and easily portable within a lightweight computing unit such as a microcontroller. However, a high number of parameters has to be stored, of the order of more than 150,000, thereby requiring a relatively high amount of static memory, such as ROM, Flash or EEPROM for example.

It is also possible to use a neural network having an architecture combining convolutional and then deconvolutional layers, in particular what is known as a “fully convolutional” architecture, comprising only convolutional/deconvolutional layers.

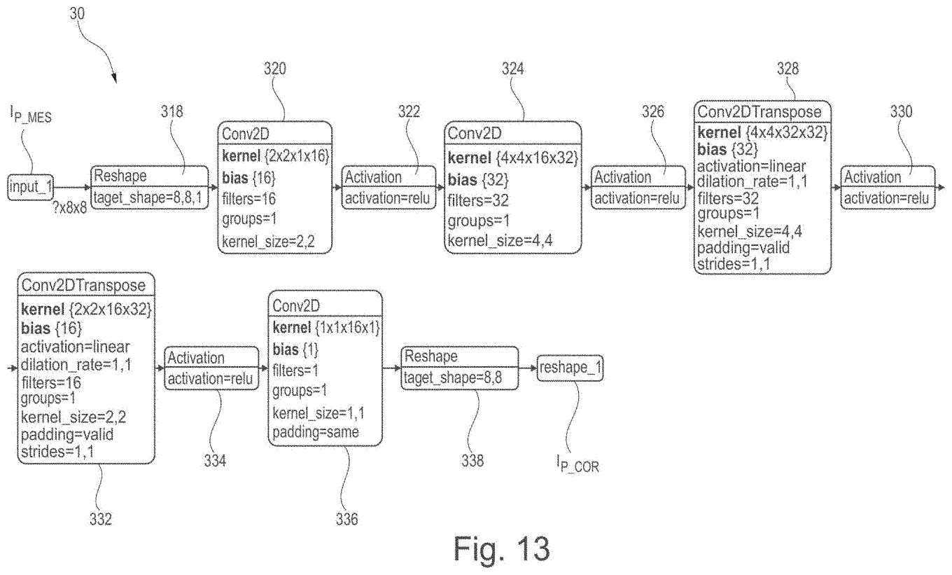

In the example illustrated in FIG. 13 for the abovementioned matrix of 8×8 pixels, use is made of two convolutional layers 320 and 324 with ReLU activations 322 and 326 successively having 16 and 32 filters of 4×4 kernels, followed by two “Conv2 DTranspose” layers 328 and 332 with ReLU activations 330 and 334 successively having 32 and 16 4×4 filters. A “Conv2D” layer 336 is added to the output with a single filter of size 1×1 and a Reshape layer 338 is used to format the output I_{P_COR} in 8×8 form.

Such an architecture requires a higher computing power than the previous one due to the succession of the convolution and deconvolution processes, but has the advantage of a small number of parameters to be stored, for example fewer than 25,000 parameters.

Other architectures are possible, for example feedforward or looped architectures, and the parameterization of the chosen architecture may vary. For example, the neural network comprises a number of hidden layers or a number of neurons per layer different from the one that has just been described.

The architecture is preferably selected just once for a given matrix 2 type or design.

When manufacturing a new specimen of this matrix, the database BD_{MES} is generated with this matrix and the neural network having the preselected architecture is trained and then validated in line with the calibration method described above.

When using the sensor, each pressure image I_{P_MES} measured by the matrix is injected into the neural network 30 thus trained in order to be corrected into an image I_{P_COR}.

This correction may be performed directly in the management electronics of the matrix 2 if said management electronics allow this, or be transferred to a terminal that receives the images I_{P_MES} transmitted by the matrix.

Of course, the invention is not limited to the examples that have just been described.

For example, the pressures exerted on the matrix 2 are not necessarily detected through a resistive measurement. They may be detected through a capacitive measurement, for example by replacing the conductive material with a material having a high dielectric constant, and for example by subjecting the measurement electrodes to AC voltages, or using any other method suitable for measuring a capacitance.

The sensor may furthermore be designed to measure other quantities in addition to pressure and/or temperature. A piezoelectric layer may be added in order to measure any vibrations or accelerations.

The sensor according to the invention may be used, inter alia, for robotic applications, in particular in the context of dextrous robotic object manipulation. The matrices are for example fastened to all of the surfaces of the gripper that are possibly in contact with objects (palm, finger, phalanges, etc.) and make it possible to estimate the position and the orientation of the object in the gripper.

In other exemplary applications, the sensor is integrated into a tactile human-machine interface or, as mentioned above, into a metrological pad such as a chiropody pad.

1. Matrix pressure sensor, comprising
a matrix of tactile pixels at least some of which have a reciprocal crosstalk effect between them,
a neural network for processing an image of the response from the sensor and providing a corrected image, this network having been trained from an augmented database comprising:
real homogeneous pressing data measured by applying a homogeneous pressure to at least some of the pixels, and
additional partial pressing data produced through simulation by applying binary masks to the real homogeneous pressing data, so as to simulate partial pressing without a crosstalk effect with the pixels situated outside partial pressing areas.

2. Sensor according to claim 1, the pixels being piezoresistive or capacitive.

3. Sensor according to claim 2, the pixels being piezoresistive, the sensor having one of the following structures:
a) A first layer of a conductive polymer,
an array of column electrodes on the outer face of this first layer of conductive polymer,
a second layer of a conductive polymer facing the first layer,
an array of row electrodes on the outer face of this second layer of conductive polymer;
b) A layer of piezoresistive material,
an array of column electrodes on a face of this first layer of piezoresistive material,
an array of row electrodes on the face opposite this layer of piezoresistive material;
c) A first electrically insulating carrier layer,
an array of column electrodes on the inner face of this first carrier layer,
a layer of a conductive polymer having a first face facing the array of column electrodes,
an array of row electrodes facing the second face of the layer of conductive polymer,
a second electrically insulating carrier layer, on the inner face of which the row electrodes are arranged;
d) A substrate,
row and column electrodes on one and the same face of this substrate,
a layer of a conductive polymer facing these row and column electrodes.

4. Sensor according to claim 1, comprising a temperature sensor, the neural network having been trained so as to take into account the influence of temperature on the behavior of the pixels, by taking the temperature as additional input.

5. Sensor according to claim 1, the neural network comprising a single convolutional layer and at least one dense layer.

6. Sensor according to claim 1, the neural network comprising convolutional layers and deconvolutional layers.

7. Sensor according to claim 1, the pixels being distributed over the matrix with an irregular distribution in at least one direction.

8. Sensor according to claim 1, comprising a processor for acquiring an image of the response from the sensor by reading out the pixels sequentially, each pixel that is read out being supplied with power and all of the other pixels that are not read out being grounded during this readout operation.

9. Method for calibrating a tactile sensor comprising a matrix of tactile pixels at least some of which have a reciprocal crosstalk effect between them, comprising the following steps:
applying a homogeneous pressure to at least some of the pixels,
thus generating a real homogeneous pressing database by acquiring the response from the sensor for various values of the applied pressure,
generating an augmented database containing additional partial pressing data obtained through simulation by applying binary masks to the real homogeneous pressing data, so as to simulate partial pressing without a crosstalk effect with the pixels situated outside partial pressing areas,
training at least one neural network to deliver a corrected image of the response from the sensor using the augmented database.

10. Method according to claim 9, wherein a plurality of neural networks with different architectures are subjected to the training, and the one with the best performance is selected by subjecting the sensor to at least one press different from a press that was used to train the networks, and by comparing the results produced by these various networks with the real data.

11. Method according to claim 10, wherein said different press consists of a homogeneous press exerted on only some of the pixels of the matrix, and wherein the selection is made on the basis of at least one selection criterion representative of the difference between the highest pixel response and the lowest pixel response for this press.

12. Method according to claim 9, wherein the neural network is trained so as to take into account the influence of temperature on the behavior of the pixels, by taking the temperature as additional input.

13. Method according to claim 9, a plurality of binary masks being used at the same time on one and the same image when forming the augmented database, while ensuring that the masks do not overlap.

14. Method according to claim 9, the binary masks being formed of pixelated ellipsoids for which the values of the major axis, minor axis, orientation and coordinates of their center on the matrix are varied.
